(19) United States
(12) Patent Application Publication
(10) Pub. No.: US 2025/0374386 A1
(43) Pub. Date: Dec. 4, 2025

(54) APPLIANCE WITH AN AUTOMATED FAN ASSEMBLY

(71) Applicant: Haier US Appliance Solutions, Inc., Wilmington, DE (US)

(72) Inventor: Bagawathkumar Chellappan, Prospect, KY (US)

(21) Appl. No.: 18/732,001

(22) Filed: Jun. 3, 2024

(51) Int. Cl. H05B 6/64; F24C 15/20

(52) U.S. Cl. CPC H05B 6/6423; F24C 15/2021; F24C 15/2042

(57) ABSTRACT

A method of operating an appliance includes a controller detecting a first air quality characteristic and comparing the first air quality characteristic to a threshold characteristic. The method also includes the controller suggesting a position of a fan housing to align an outlet with a selected one of a plurality of discharge ports and the controller receiving an input indicative of the selected one of the plurality of discharge ports. The method further includes the controller adjusting the fan housing to the suggested position in response to the received input and operating a fan wheel to circulate air through the selected one of the plurality of discharge ports.

### FIELD OF THE INVENTION

The present subject matter relates generally to appliances, and more particularly to fan assemblies in over-the-range appliances.

### BACKGROUND OF THE INVENTION

Over-the-range microwave appliances are generally mounted above a cooktop of an oven range appliance. In addition to providing for heating of food and beverage items, certain over-the-range microwave appliances include a circulation system. When activated, the circulation system can draw fumes, smoke, grease, and/or steam away from the cooktop of the oven range appliance. Circulation systems generally include a fan for drawing a flow of air into the circulation system and a grease filter for trapping grease entering the circulation system.

Over-the-range microwave appliances generally have a radial blower fan that can be adjusted to recirculate or externally vent through an air vent. The installer of the microwave appliance can adjust the blower fan by removing certain parts to access and remove the radial blower fan, in order to reposition the fan. In other words, to switch venting directions after installation of the microwave appliance, the microwave appliance needs to be uninstalled and then reinstalled with the fan repositioned to change the venting direction. At times, installers may overlook ducting in the home and install the microwave appliance without properly orienting the blower fan to the functional position. This can lead to the failure of the magnetron and the cooking air not being vented in the desired direction for the consumer.

Accordingly, a microwave appliance with features for adjusting the circulation of the microwave appliance without uninstalling and reinstalling the fan would be useful.

### BRIEF DESCRIPTION OF THE INVENTION

Aspects and advantages of the invention will be set forth in part in the following description, or may be apparent from the description, or may be learned through practice of the invention.

In a first example embodiment, a method of operating a microwave appliance is provided. The microwave appliance includes a casing that defines a cooking chamber and a circulation conduit. The circulation conduit has an inlet and an outlet. A controller is disposed within the microwave appliance. The controller is in wireless communication with an external device over a network. A fan assembly is positioned within the circulation conduit of the casing. The fan assembly is in signal communication with the controller. The fan assembly includes a discharge housing comprising a plurality of discharge ports, and a fan housing comprising an outlet and a toothed gear. The fan housing is mounted within the discharge housing. The fan assembly also includes a fan wheel rotatably mounted within the fan housing, and an auxiliary motor positioned adjacent the discharge housing and mechanically coupled to the toothed gear. The controller of the microwave appliance is in operable communication with the auxiliary motor. The method includes the controller detecting a first air quality characteristic and comparing the first air quality characteristic to a threshold characteristic. The method also includes the controller suggesting a position of the fan housing to align the outlet with a selected one of the plurality of discharge ports and the controller receiving an input indicative of the selected one of the plurality of discharge ports. The method further includes the controller adjusting the fan housing to the suggested position in response to the received input and operating the fan wheel to circulate air through the selected one of the plurality of discharge ports.

In a second example embodiment, a microwave appliance is provided. The microwave appliance includes a casing that defines a cooking chamber and a circulation conduit. The circulation conduit has an inlet and an outlet. A controller is disposed within the microwave appliance. The controller is in wireless communication with an external device over a network. A fan assembly is positioned within the circulation conduit of the casing. The fan assembly is in signal communication with the controller. The fan assembly includes a discharge housing comprising a plurality of discharge ports, and a fan housing comprising an outlet and a toothed gear. The fan housing is mounted within the discharge housing. The fan assembly also includes a fan wheel rotatably mounted within the fan housing, and an auxiliary motor positioned adjacent the discharge housing and mechanically coupled to the toothed gear. The controller of the microwave appliance is in operable communication with the auxiliary motor. The controller is configured to detect a first air quality characteristic and compare the first air quality characteristic to a threshold characteristic. The controller is also configured to suggest a position of the fan housing to align the outlet with a selected one of the plurality of discharge ports and the controller is configured to receive an input indicative of the selected one of the plurality of discharge ports. The controller is further configured to adjust the fan housing to the suggested position in response to the received input and operate the fan wheel to circulate air through the selected one of the plurality of discharge ports.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave appliance according to an example embodiment of the present subject matter mounted to a kitchen cabinet above an oven range appliance.

FIG. 2 provides a side, section view of the example microwave appliance and the oven range appliance of FIG. 1.

FIG. 3 provides a front view of a fan assembly of the example microwave appliance of FIG. 1.

FIG. 4 provides a side view of the fan assembly of FIG. 3 according to aspects of the present disclosure.

FIG. 5 provides a perspective view of an example embodiment of an example microwave appliance with the fan assembly of FIG. 3 in a first position.

FIG. 6 provides a perspective view of an example embodiment of an example microwave appliance with the fan assembly of FIG. 3 in a second position.

FIG. 7 provides a perspective view of an example embodiment of an example microwave appliance with the fan assembly of FIG. 3 in a third position.

FIG. 8 illustrates a perspective view of an example embodiment of a fan assembly according to aspects of the present disclosure.

FIG. 9 illustrates an example network according to aspects of the present disclosure.

FIG. 10 illustrates a flowchart of an example method of operating a microwave appliance according to aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

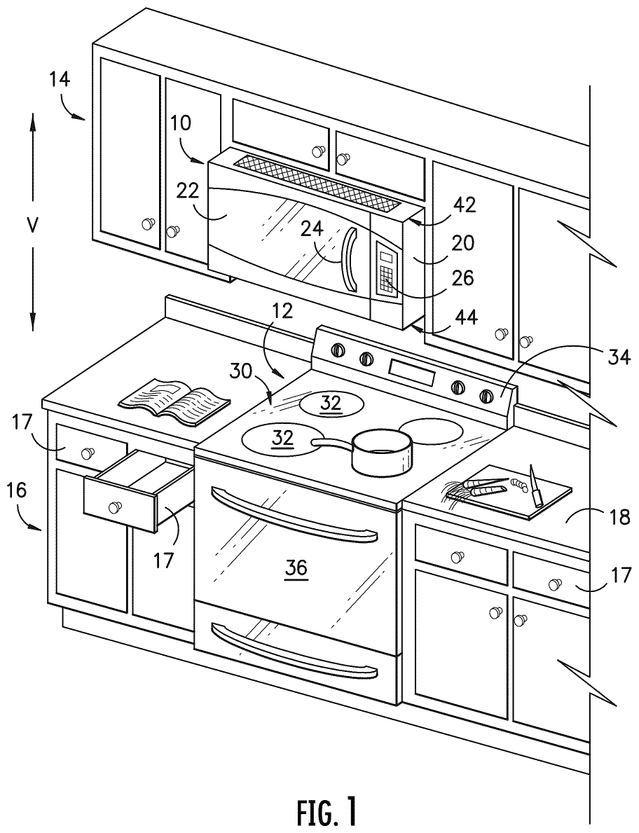

FIG. 1 provides a perspective view of a microwave appliance 10 according to an example embodiment of the present subject matter mounted to an upper set of kitchen cabinets 14 above an oven range appliance 12, e.g., along a vertical direction V. Microwave appliance 10 shown in FIG. 1 is commonly referred to as an over-the-range microwave. It should be understood that, in alternative example embodiments, the present subject matter may be used in any other suitable microwave appliance.

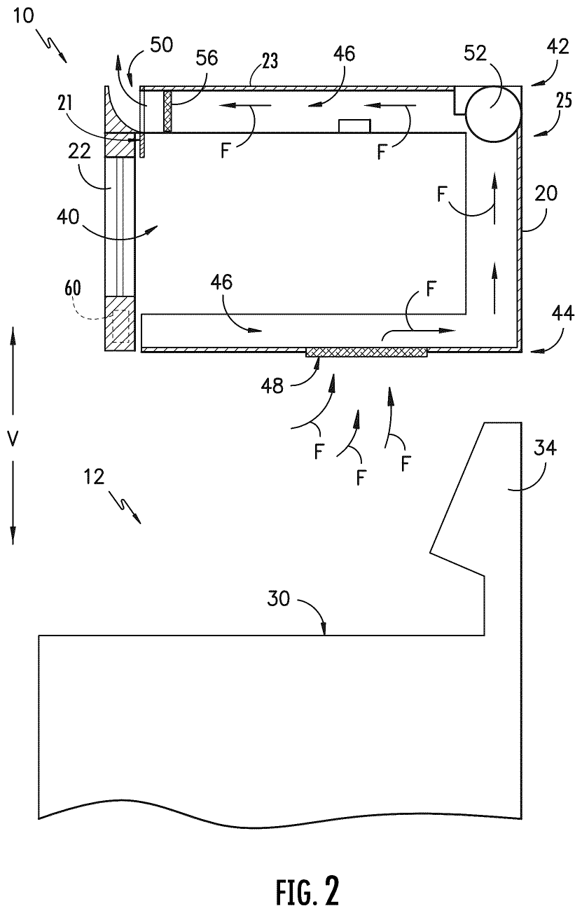

As discussed above, microwave appliance 10 is mounted to upper set of kitchen cabinets 14. Upper set of kitchen cabinets 14 is positioned above a base set of kitchen cabinets 16, e.g., along the vertical direction V. Base set of kitchen cabinets 16 includes countertops 18 and drawers 17. Microwave appliance 10 is positioned above base set of kitchen cabinets 16, e.g., along the vertical direction V. Oven range appliance 12 is received within base set of kitchen cabinets 16 below microwave appliance 10. In particular, a cooking surface 30 of oven range appliance 12 is positioned, e.g., directly, below microwave appliance 10 along the vertical direction V. Microwave appliance 10 can include features such as an air handler or fan assembly 52 (FIG. 2) that can draw cooking vapors and/or smoke away from cooking surface 30 and out of the kitchen containing microwave and oven range appliances 10 and 12.

Microwave appliance 10 is configured for receipt of food items for cooking. In particular, microwave appliance 10 includes a cabinet or casing 20 and a door 22 that permits selective access to an interior of microwave appliance 10 and casing 20. Door 22 includes a handle 24 that a user can pull to open door in order to insert food items into microwave appliance 10. Microwave appliance 10 also includes controls 26 that permit a user to make selections for cooking of food items, e.g., a duration of a cooking cycle of microwave appliance 10 and/or a power setting for the cooking cycle of microwave appliance 10.

As discussed above, oven range appliance 12 includes cooking surface 30. Cooking surface 30 includes heated portions 32 that may be heated by heating elements (not shown), e.g., electrical resistive heating elements, gas burners, induction heating elements, and/or any other suitable heating element of combination of heating elements. Oven range appliance 12 also includes a door 36 that permits access to a heated compartment (not shown) of oven range appliance 12, e.g., for cooking or baking of food items therein. A control panel 34 of oven range appliance 12 can permit a user to make selections for cooking of food items, e.g., a duration of a cooking cycle of oven range appliance 12 and/or a power setting for the cooking cycle of oven range appliance 12.

FIG. 2 provides a side, section view of microwave appliance 10 and oven range appliance 12. As may be seen in FIG. 2, casing 20 extends between a top portion 42 and a bottom portion 44, e.g., along the vertical direction V. Thus, top, and bottom portions 42 and 44 of casing 20 are spaced apart from each other, e.g., along the vertical direction V. In particular, casing 20 may include a front wall 21, a top wall 23, and a back wall 25 as will be described further hereinbelow. Casing 20 may generally define a cooking chamber 40 configured for receipt of food items for cooking. Door 22 positioned adjacent to front wall 21 of casing 20 of microwave appliance 10 permits selective access to cooking chamber 40 of casing 20. In particular, door 22 of microwave appliance 10 is selectively adjustable between an open position (not shown) and a closed position (FIGS. 1 and 2). In the closed position, door 22 of microwave appliance 10 hinders access to cooking chamber 40 of casing 20. Conversely, door 22 of microwave appliance 10 permits access to cooking chamber 40 of casing 20 in the open position. A user can pull on handle 24 of door 22 of microwave appliance 10 in order to shift door 22 from the closed position shown in FIG. 2 to the open position.

Casing 20 also defines a circulation passage or conduit 46. Circulation conduit 46 has an inlet 48 and an outlet 50. Circulation conduit 46 extends between inlet 48 and outlet 50. Inlet 48 of circulation conduit 46 is positioned at or adjacent bottom portion 44 of casing 20, e.g., such that inlet 48 of circulation conduit 46 faces cooking surface 30 of oven range appliance 12. Conversely, outlet 50 of circulation conduit 46 is positioned at or adjacent top portion 42 of casing 20, e.g., such that outlet 50 of circulation assembly 46 faces away from cooking surface 30 of oven range appliance 12. Thus, inlet 48 and outlet 50 of circulation conduit 46 are spaced apart from each other, e.g., along the vertical direction V.

Microwave appliance 10 may include a fan assembly 52, such as an axial fan or a radial fan. Fan assembly 52 may be positioned within or adjacent circulation conduit 46. Fan assembly 52 may draw or urge a flow of air (shown with arrows F) through circulation conduit 46 when fan assembly 52 is in an activated state. Conversely, fan assembly 52 may not draw or urge flow of air F through circulation conduit 46 when fan assembly 52 is in a deactivated state. When fan assembly 52 is in the activated state, flow of air F enters circulation conduit 46 at, or through, inlet 48 of circulation conduit 46. In the present example embodiment, flow of air Fis directed through circulation conduit 46 to outlet 50, and flow of air F can exit circulation conduit 46 at outlet 50 of circulation conduit 46. As described above, fan assembly 52 is described in a recirculation orientation where flow of air F is directed through circulation conduit 46 to outlet 50, however, fan assembly 52 may be configurable to direct flow of air F in other desired directions. Fan assembly 52, and other possible orientations of fan assembly 52 will be described in further detail hereinbelow.

Microwave appliance 10 may also include an air filter 56. Air filter 56 may be mounted to casing 20 such that flow of air F within circulation conduit 46 passes through air filter 56 when fan assembly 52 is in the activated state. In the example embodiment shown in FIG. 2, air filter 56 is positioned within circulation conduit 46 at outlet 50 of circulation conduit 46. It should be understood that in alternative example embodiments, air filter 56 may be positioned at any other suitable location on microwave appliance 10. In some example embodiments, filter 56 may include air freshener, e.g., air deodorant and/or air purifier to aid in reducing cooking odors.

As may be seen in FIG. 2, microwave appliance 10 includes a controller 60. Operation of microwave appliance 10 is regulated by controller 60. Controller 60 is operatively coupled or in communication with various components of microwave appliance 10, including controls 26. In response to user manipulation of controls 26, controller 60 operates the various components of microwave appliance 10 to execute selected cycles and features.

Controller 60 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 60 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 26 and other components of microwave appliance 10 may be in communication with controller 60 via one or more signal lines or shared communication busses.

Microwave appliance 10 also includes a magnetron 62. Magnetron 62 is configured for generating microwaves and directing such microwaves towards or into cooking chamber 40 of casing 20. Magnetron 62 can be positioned at any suitable location within microwave appliance 10. For example, magnetron 62 may be mounted to casing 20, e.g., at or adjacent top portion 42 of casing 20, such that magnetron 62 is positioned at or adjacent cooking chamber 40 of casing 20. Controller 60 can selectively activate magnetron 62, e.g., in order to heat food or beverage items in cooking chamber 40, based at least in part on an activation signal received from controls 26. Further, controller 60 may also be in operative communication with fan assembly 52. Thus, controller 60 may selectively adjust fan assembly 52 between the activated and deactivated states in order to regulate the flow of air F through circulation conduit 46.

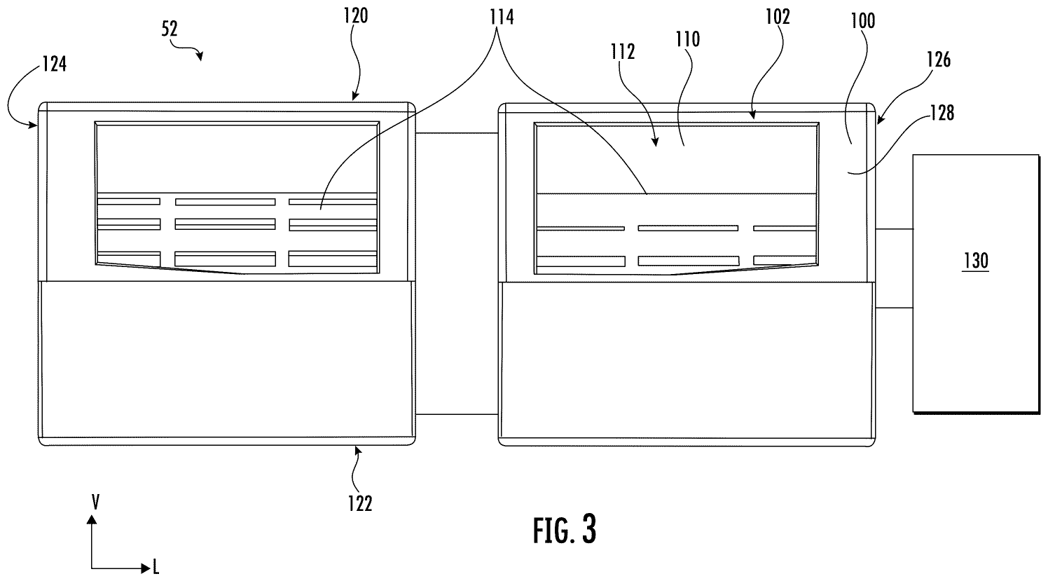

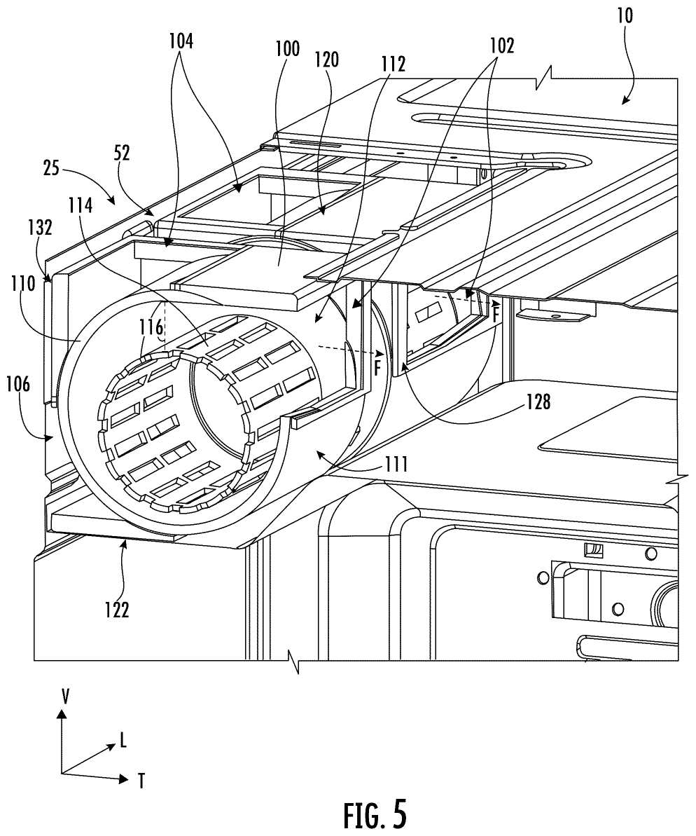

Illustrated in FIGS. 3-7 is example embodiment of fan assembly 52. As may be seen in FIGS. 3-7, fan assembly 52 may include a discharge housing 100. In general, discharge housing 100 may extend between a top side 120, a bottom side 122, a first side wall 124, a second side wall 126, a front side 128, and a back side 132, e.g., discharge housing 100 may be generally rectangular in shape. As may be seen in FIG. 3, discharge housing 100 may be divided into two sections in the lateral direction L, e.g., discharge housing 100 may be two independent sections. Discharge housing 100 may generally define a plurality of discharge ports, e.g., a first discharge port 102, a second discharge port 104, and a third discharge port 106. In example embodiments, the plurality of discharge ports 102, 104, and 106 includes three discharge ports, first discharge port 102, second discharge port 104, and third discharge port 106, facing in different directions. For example, first discharge port 102 may be defined in front side 128 of discharge housing 100 (e.g., the first discharge port 102 may generally face forward along the transverse direction T), second discharge port 104 may be defined in top side 120 of discharge housing 100 (e.g., the second discharge port 104 may generally face upward along the vertical direction V), and third discharge port 106 may be defined in back side 132 of discharge housing 100 (e.g., the third discharge port 106 may generally face backward along the transverse direction T). As may be seen in FIG. 5, the plurality of discharge ports 102, 104, and 106 may each be defined as pairs of discharge ports, such as one port on each section of discharge housing 100 forming pairs of discharge ports.

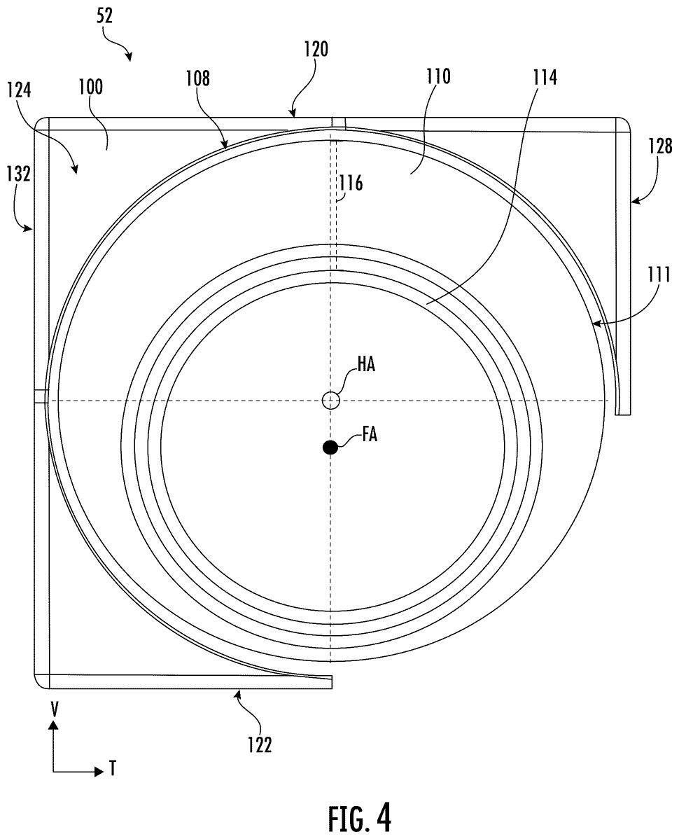

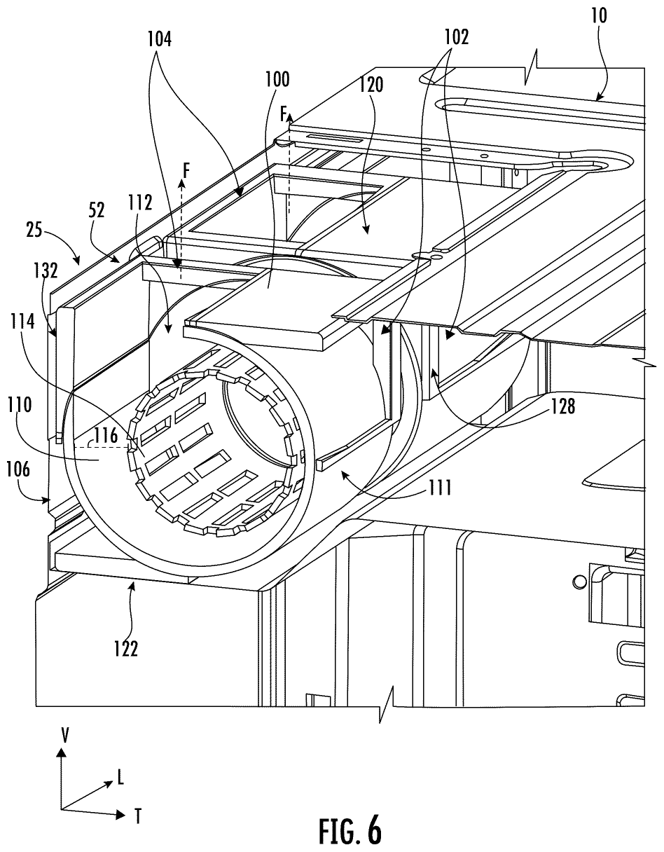

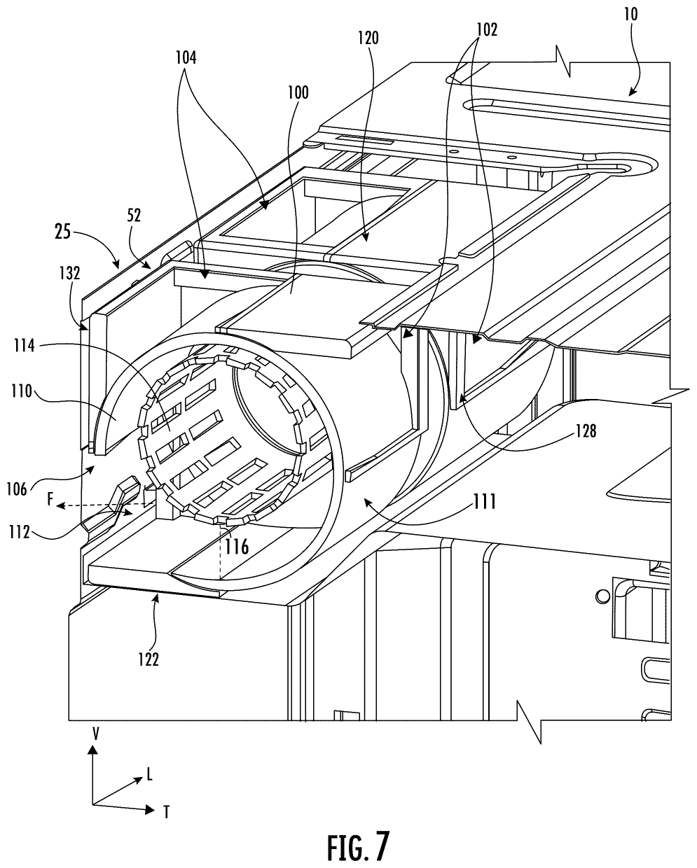

As may be seen in FIG. 3, a fan housing 110 may be mounted within discharge housing 100, e.g., fan housing 110 may include two sections, e.g., one in each respective section of discharge housing 100. In particular, turning to FIG. 4, discharge housing 100 may include an opening 108, e.g., a cylindrically shaped opening in each of first side wall 124 and second side wall 126 of discharge housing 100. Fan housing 110 may include an outer surface 111 and may be cylindrical, and concentric with opening 108 of discharge housing 100, such that fan housing 110 fits within opening 108 in both of the transverse direction T and vertical direction V. In other words, fan housing 110 may be laterally, in the lateral direction L, positioned within, and rotatable within, opening 108 of the discharge housing 100. For example, in the present example embodiment, fan housing 110 may be selectively rotatable within discharge housing 100. In particular, fan housing 110 may include an outlet 112, in each respective section within discharge housing 100, configured to align with a selected one of the plurality of discharge ports 102, 104, and 106. For example, fan housing 110 may be rotatable between a first position (as seen in FIG. 5), wherein outlet 112 is aligned with first discharge port 102 and flow of air F is directed through first discharge port 102, a second position (as seen in FIG. 6), wherein outlet 112 is aligned with second discharge port 104 and flow of air F is directed through second discharge port 104, and a third position (as seen in FIG. 7), wherein outlet 112 is aligned with third discharge port 106 and flow of air F is directed through third discharge port 106. Notably, fan housing 110 may be rotatable within discharge housing 100 while the discharge housing 100 and fan housing 110 are installed within microwave appliance 10.

Referring again to FIGS. 3-7, in general, fan housing 110 may include a fan wheel 114, e.g., in each section of fan housing 110. In particular, fan wheel 114 may be rotatably mounted within fan housing 110 such that fan wheel 114 may be configured to circulate air through outlet 112 of fan housing 110 and the selected one of the plurality of discharge ports 102, 104, and 106. For example, fan wheel 114 may be mechanically coupled to a motor 130 (FIG. 3) generally configured to rotate fan wheel 114 within fan housing 110. Turning again to FIG. 4, fan wheel 114 may be mounted within fan housing 110 on a fan axis FA parallel to, and spaced apart from, a housing axis HA of the fan housing. As such, an inside gap 116 of fan housing 110 from fan wheel 114 may be non-uniform and progressively increasing towards outlet 112 of the fan housing 110. For example, as explained above, fan housing 110 may be selectively rotatable within discharge housing 100 between the plurality of discharge ports 102, 104, and 106, and offsetting fan axis FA from housing axis HA may thereby keep inside gap 116 of fan housing 110 from fan wheel 114 non-uniform and progressively increasing towards outlet 112 of fan housing 110 with respect to the selected one of the plurality of discharge ports 102, 104, and 106.

As stated above, fan housing 110 may be rotatable between a first position where outlet 112 is aligned with first discharge port 102, a second position where outlet 112 is aligned with second discharge port 104, and a third position where outlet 112 is aligned with third discharge port 106. As may be seen in FIG. 5, fan housing 110 is shown in the first position, with outlet 112 aligned with first discharge port 102. When in the first position, flow of air F may flow out of first discharge port 102 of discharge housing 100 in the transverse direction T, such that air may be recirculated through circulation conduit 46 (e.g., as seen in FIG. 2). Turning to FIG. 6, fan housing 110 is shown in the second position, with outlet 112 aligned with second discharge port 104. When in the second position, flow of air F may flow out of second discharge port 104 of discharge housing 100 in the vertical direction V, such that flow of air F may flow out an external duct (not shown) extending in the vertical direction V. Further, turning to FIG. 7, fan housing 110 is shown in the third position, with outlet 112 aligned with third discharge port 106. When in the third position, flow of air F may flow out of third discharge port 106 of discharge housing 100 in the transverse direction T, opposite the direction of the first position, such that flow of air F may flow out back side 132 of discharge housing 100 and out an external duct (not shown) in the transverse direction T.

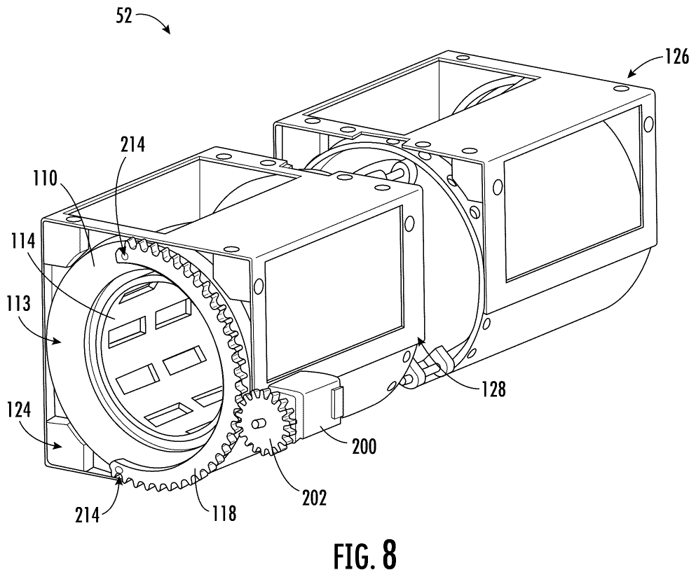

Turning now to FIG. 8, in the present example embodiment, fan assembly 52 may include a toothed gear 118. Toothed gear 118 may generally be mounted to a first side 113 of fan housing 110, e.g., toothed gear 118 may define a pair of mounting holes 214, whereby toothed gear 118 may be coupled to fan housing 110 via fasteners through the pair of mounting holes 214. In general, fan housing 110 may be selectively rotatable within discharge housing 100 while installed within microwave appliance 10 via rotating toothed gear 118. For example, toothed gear 118 may be a semi-circular gear, curved rack, or other suitable structure for rotating fan housing 110 within discharge housing 100 while the discharge housing 100 and fan housing 110 are installed within microwave appliance 10. Additionally or alternatively, fan assembly 52 may be configured to be used in other suitable appliances or structures such as heating, ventilation, and air conditioning systems (HVAC) or vent hood appliances.

In the present example embodiment, fan assembly 52 may include an auxiliary motor 200 mechanically coupled to toothed gear 118. For example, fan assembly 52 may include a rack and pinion assembly, e.g., auxiliary motor 200 may include a transmission, such as a gear (pinion) 202, positioned to engage the toothed gear 118 (rack) of fan housing 110. In other words, the pinion (gear 202) of auxiliary motor 200 may be mechanically coupled to the rack (toothed gear 118). In particular, auxiliary motor 200 may be positioned adjacent discharge housing 100 such that auxiliary motor 200 may be mechanically coupled to toothed gear 118, thereby auxiliary motor 200 may be configured to rotate toothed gear 118 and fan housing 110. In general, auxiliary motor 200 may include a brushless DC electric motor, a stepper motor, or any other suitable type or configuration of motor. For example, auxiliary motor 200 may include an AC motor, an induction motor, a permanent magnet synchronous motor, or any other suitable type of AC motor. In addition, auxiliary motor 200 may include any suitable transmission assemblies, clutch mechanisms, or other components, such as gear 202. According to an example embodiment, auxiliary motor 200 may be operably coupled to controller 60, which is programmed to rotate fan housing 110 as described herein. In general, fan assembly 52 may be in signal communication with controller 60. For example, controller 60 of microwave appliance 10 may be in operable communication with auxiliary motor 200, such that controller 60 may rotate fan housing 110 between the first, second, and third positions as described herein.

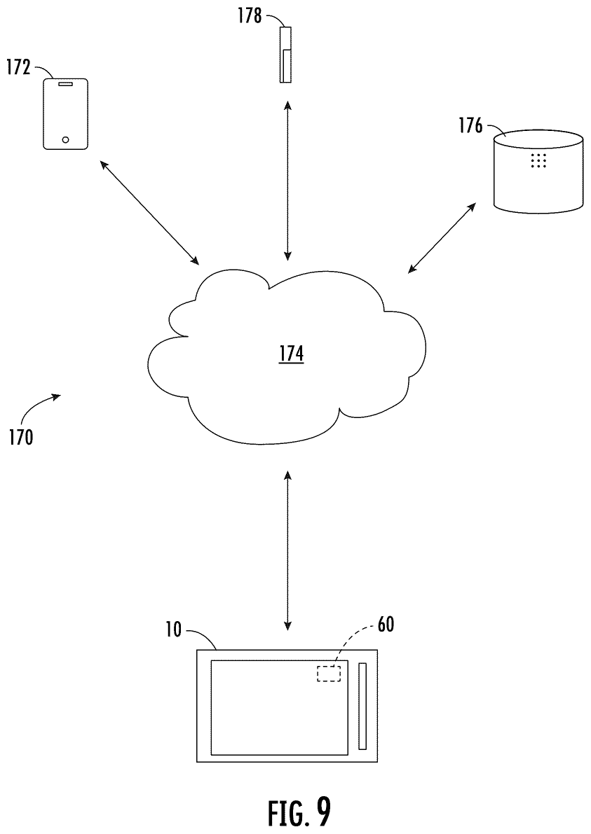

Furthermore, turning to FIG. 9, controller 60 may be in wireless communication with an external device, such as one or more of a smartphone, referred to generally as external device 172, a sensor 178, and a database 176, over a network 174. In particular, FIG. 9 illustrates a schematic diagram of an external communication system 170 which will be described according to an example embodiment of the present subject matter. In general, external communication system 170 is configured for permitting interaction, data transfer, and other communications between microwave appliance 10 and one or more external devices. For example, this communication may be used to provide and receive operating parameters, user instructions or notifications, performance characteristics, user preferences, or any other suitable information for improved performance of microwave appliance 10. In addition, it should be appreciated that external communication system 170 may be used to transfer data or other information to improve performance of one or more external devices or appliances and/or improve user interaction with such devices.

For example, external communication system 170 permits controller 60 of microwave appliance 10 to communicate with a separate device external to microwave appliance 10, such as external device 172, sensor 178, and/or database 176. These communications may be facilitated using a wired or wireless connection, such as via network 174. In general, external device 172 may be any suitable device separate from microwave appliance 10 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device. Additionally, sensor 178 may be, for example, one or more of a temperature sensor, a humidity sensor, a particle (allergen) sensor, and a smoke detector sensor. Furthermore, a user may establish preset values for each of the sensors/conditions, e.g., according to their preferences of indoor air comfort, or the user may use recommended preset values, such as from sensor manufacturers, weather reports, or government agencies. The preset values may be customized by the user, and controller 60 may be set to activate fan assembly 52 for either internal or external venting. Furthermore, a speed, such as revolutions per minute (RPM's), of fan wheel 114 may be programable by the user, such as a “low” speed and a “high” speed, where the “low” speed is less RPMs than the “high” speed of fan wheel 114. Moreover, controller 60 may be configured to deactivate fan assembly 52 and return fan housing 110 back to a previous or original position after the internal air quality is satisfied to the preset values. Accordingly, in response to the sensors/conditions, controller 60 may be configured to notify the user and request permission to activate fan assembly 52 or may be configured to activate fan assembly 52 automatically.

In addition, a remote server, or database 176 may be in communication with microwave appliance 10 and/or external device 172 through network 174. In this regard, for example, database 176 may be a cloud-based server, and is thus located at a distant location, such as in a separate state, country, etc. According to an example embodiment, external device 172 may communicate with database 176 over network 174, such as the Internet, to transmit/receive data or information, provide user inputs, receive user notifications or instructions, interact with or control microwave appliance 10, etc. In addition, external device 172 and database 176 may communicate with microwave appliance 10 to communicate similar information.

In general, communication between microwave appliance 10, external device 172, database 176, sensor 178, and/or other user devices or appliances may be carried using any type of wired or wireless connection and using any suitable type of communication network, non-limiting examples of which are provided below. For example, external device 172 may be in direct or indirect communication with microwave appliance 10 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an example embodiment of the present subject matter. However, it should be appreciated that the example functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

For example, controller 60 may communicate with external device 172, database 176, and/or sensor 178 to determine existing exterior conditions, such as temperature, allergens (pollen), and smoke, inside and/or outside of a residence, whereby controller 60 may operate auxiliary motor 200 to rotate fan housing 110 to one of the first, second, and third positions in order to blow air from fan assembly 52 to a desired location. In one example scenario, when outside conditions are cold, e.g., sensor 178 communicates an external temperature (outside of the residence) of thirty-two degrees Fahrenheit (32° F.), controller 60 may operate auxiliary motor 200 to reposition fan housing 110 to the first position, recirculating the air through circulation conduit 46 such as to conserve energy by not venting hot air externally (out of the residence) when cooking food. In another example scenario, when food being cooked produces unwanted smoke, vapors and/or cooking odors, controller 60 may operate auxiliary motor 200 to reposition fan housing 110 to the second position, such that flow of air F may flow out an external duct (not shown), e.g., ejecting the unwanted smoke and vapors outside of the residence.

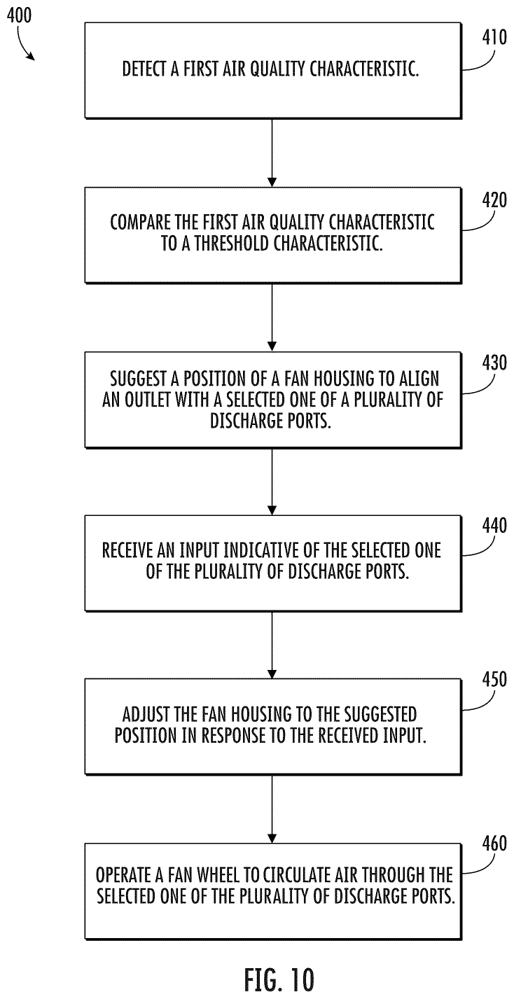

Furthermore, it should be noted that controller 60 may be capable of and may be operable to perform any methods, method steps, or portions of methods as disclosed hereinbelow. For example, in some embodiments, methods disclosed hereinbelow may be embodied in programming instructions stored in the memory and executed by controller 60. Specifically, referring now to FIG. 10, a flow diagram of one embodiment of a method 400 of operating microwave appliance 10 is illustrated in accordance with aspects of the present subject matter. In general, method 400 will be described herein with reference to the embodiments of microwave appliance 10 above with reference to FIGS. 1-9. However, it should be appreciated by those of ordinary skill in the art that the disclosed method 400 may generally be utilized in association with apparatuses and systems having any other suitable configuration, such as a microwave appliance with additional or less circulation conduits. In addition, although FIG. 10 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure. Additionally, it should be noted that various steps of method 400 may occur any time before, during, and/or after cooking operations, e.g., the heating of food or beverage items in cooking chamber 40, of microwave appliance 10.

As shown in FIG. 10, at (410), method 400 may generally include detecting a first air quality characteristic by controller 60. In general, the first air quality characteristic may be either of an indoor air quality characteristic, such as within a room or space (e.g., a kitchen) where microwave appliance 10 is located, or an outdoor air quality characteristic, such as externally from where microwave appliance 10 is located (e.g., outside of the house/building or structure). In particular, detecting the first air quality characteristic may include receiving data from external device 172, database 176, and/or sensor 178 over network 174. As such, detecting the first air quality characteristic may include controller 60 receiving one or more of a temperature, an allergen content, and a smoke content of air transmitted from one or more of external device 172, database 176, and/or sensor 178. For example, controller 60 may detect air quality through a sensor integral to microwave appliance 10 or external sensors/devices, e.g., external device 172 may communicate to controller 60 directly or may communicate through a mobile app installed on the external device.

At (420), method 400 may generally include comparing the first air quality characteristic to a threshold characteristic by controller 60. In general, the threshold characteristic may be one or more of a threshold temperature, humidity, allergen content, and/or smoke content of air. In general, a user may be able to set the threshold to a desired value, such as a threshold temperature of seventy-two degrees Fahrenheit (72° F.) or such as a threshold allergen content of air of 50 on the U.S. Air Quality Index (AQI). For example, controller 60 may detect the first air quality characteristic as an outdoor air quality characteristic of thirty-two degrees Fahrenheit (32° F.), and controller 60 may compare thirty-two degrees Fahrenheit (32° F.) with the threshold temperature, set by the user, of seventy-two degrees Fahrenheit (72° F.), thereby determining that the detected first air quality characteristic is below the threshold characteristic.

At (430), method 400 may generally include suggesting a position of fan housing 110 to align outlet 112 with a selected one of the plurality of discharge ports 102, 104, and 106. For example, the suggested position of fan housing 110 may be one of the first position, the second position, or the third position as described above. In general, suggesting the position of fan housing 110 to align outlet 112 with the selected one of the plurality of discharge ports 102, 104, and 106 may include controller 60 transmitting a notification, such as a push notification, indicative of the suggested position to external device 172. For example, controller 60 may transmit the notification to a user's smartphone (i.e., external device 172), where the user may see and select the suggested positioning of fan housing 110.

At (440), method 400 may generally include receiving an input indicative of the selected one of the plurality of discharge ports 102, 104, and 106 at controller 60. For example, receiving the input indicative of the selected one of the plurality of discharge ports 102, 104, and 106 may include external device 172 transmitting a signal indicative of the discharge port of the plurality of discharge ports 102, 104, and 106 that has been selected, e.g., the selected discharge port may be the discharge port of the plurality of discharge ports 102, 104, and 106 that coincides with the suggested position of fan housing 110, such as the first position where outlet 112 of fan housing 110 is aligned with first discharge port 102, the second position where outlet 112 of fan housing 110 is aligned with second discharge port 104, and the third position where outlet 112 of fan housing 110 is aligned with third discharge port 106.

At (450), method 400 may generally include adjusting fan housing 110 to the suggested position in response to the received input at controller 60. As explained in detail above, auxiliary motor 200 may generally be configured to rotate fan housing 110. As such, adjusting fan housing 110 to the suggested position by controller 60 may generally include controller 60 operating auxiliary motor 200 to rotate fan housing 110 such that outlet 112 of fan housing 110 aligns with the selected one of the plurality of discharge ports 102, 104, and 106.

At (460), method 400 may generally include operating fan wheel 114 to circulate air, internally or externally, through the selected one of the plurality of discharge ports 102, 104, and 106. Accordingly, depending on the selected one of the plurality of discharge ports 102, 104, and 106, air may be exhausted externally, or recirculated into the room or space (e.g., the kitchen) where microwave appliance 10 is located. In particular, in one example embodiment, operating fan wheel 114 to circulate air through the selected one of the plurality of discharge ports 102, 104, and 106 may include circulating air through the first discharge port 102 while in the first position, thereby recirculating the air through circulation conduit 46. In another example embodiment, operating fan wheel 114 to circulate air through the selected one of the plurality of discharge ports 102, 104, and 106 may include circulating air through the second discharge port 104 while in the second position, such that flow of air F may flow out an external duct (not shown).

In some example embodiments, method 400 may further include detecting a second air quality characteristic and comparing the second air quality characteristic to the threshold characteristic. For example, the second air quality characteristic may be an indoor air quality characteristic, such as temperature, humidity, smoke content in air. In general, comparing the second air quality characteristic to the threshold characteristic may generally include controller 60 determining the second air quality characteristic satisfies the threshold characteristic, e.g., equals or is desirably higher/lower. Accordingly, method 400 may further include deactivating fan wheel 114 in response to determining the second air quality characteristic satisfies the threshold characteristic.

For example, the second air quality characteristic may be the detection of smoke by a smoke detector, i.e., sensor 178, whereupon controller 60 may compare the second air quality characteristic with the threshold characteristic. In this example scenario, the second air quality characteristic may be a positive indication of smoke in the air of the room or space where microwave appliance 10 is located, and the threshold characteristic may be a negative indication of smoke in the air. Accordingly, fan wheel 114 may continue operating (e.g., expelling smoke out of either second discharge port 104 or third discharge port 106) until controller 60 determines the second air quality characteristic satisfies the threshold characteristic, e.g., the second air quality characteristic is a negative indication of smoke, whereby controller 60 may deactivate fan wheel 114.

As may be seen from the above, a modular discharge casing in an over-the-range microwave appliance may include a fan housing. The discharge casing may allow the fan housing to rotate therein. Additionally, the discharge casing may be equipped with multiple openings, allowing the fan housing to be rotated and aligned with any of these openings. Advantageously, the fan housing may be automatically rotatable within the discharge casing while the discharge casing and fan housing are installed within the microwave appliance via an auxiliary motor. Thus, installation and maintenance may be simplified and also flexibility may be provided for directing the airflow to specific locations or accommodating different configurations without removing the modular discharge casing from the microwave appliance, hence advantageously making the discharge casing of the over-the-range microwave appliance convenient for the users.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating an appliance, the appliance comprising a casing that defines a circulation conduit, the circulation conduit having an inlet and an outlet, a controller disposed within the appliance, the controller in wireless communication with an external device over a network, and a fan assembly positioned within the circulation conduit of the casing, the fan assembly in signal communication with the controller, the fan assembly comprising a discharge housing comprising a plurality of discharge ports, a fan housing comprising an outlet and a toothed gear, the fan housing mounted within the discharge housing, a fan wheel rotatably mounted within the fan housing, and an auxiliary motor positioned adjacent the discharge housing and mechanically coupled to the toothed gear, wherein the controller of the appliance is in operable communication with the auxiliary motor, the method comprising:
detecting, by the controller, a first air quality characteristic;
comparing, by the controller, the first air quality characteristic to a threshold characteristic;
suggesting, by the controller, a position of the fan housing to align the outlet with a selected one of the plurality of discharge ports;
receiving, at the controller, an input indicative of the selected one of the plurality of discharge ports;
adjusting, by the controller, the fan housing to the suggested position in response to the received input; and
operating, by the controller, the fan wheel to circulate air through the selected one of the plurality of discharge ports.

2. The method of claim 1, further comprising detecting a second air quality characteristic and comparing the second air quality characteristic to the threshold characteristic.

3. The method of claim 2, wherein comparing the second air quality characteristic to the threshold characteristic comprises determining the second air quality characteristic satisfies the threshold characteristic, further comprising deactivating the fan wheel in response to determining the second air quality characteristic satisfies the threshold characteristic.

4. The method of claim 1, wherein suggesting the position of the fan housing to align the outlet with the selected one of the plurality of discharge ports comprises transmitting a notification indicative of the suggested position to the external device.

5. The method of claim 1, wherein receiving the input indicative of the selected one of the plurality of discharge ports comprises the external device transmitting a signal indicative of the discharge port of the plurality of discharge ports that has been selected.

6. The method of claim 1, wherein adjusting the fan housing to the suggested position comprises operating the auxiliary motor to rotate the fan housing such that the outlet of the fan housing aligns with the selected one of the plurality of discharge ports.

7. The method of claim 1, wherein detecting the first air quality characteristic comprises receiving data from the external device, wherein the external device is one or more of a database, a smartphone, and a sensor.

8. The method of claim 1, wherein detecting the first air quality characteristic comprises detecting one or more of temperature, allergen content, and smoke content of air.

9. The method of claim 1, wherein the plurality of discharge ports comprises three discharge ports facing in three different directions.

10. The method of claim 9, wherein one of the three discharge ports is positioned on a top side of the discharge housing, one of the three discharge ports is positioned on a front side of the discharge housing, and one of the three discharge ports is positioned on a back side of the discharge housing.

11. An appliance comprising:
a casing that defines a circulation conduit, the circulation conduit having an inlet and an outlet;
a controller disposed within the appliance, the controller in wireless communication with an external device over a network; and
a fan assembly positioned within the circulation conduit of the casing, the fan assembly in signal communication with the controller, the fan assembly comprising:
a discharge housing comprising a plurality of discharge ports;
a fan housing comprising an outlet and a toothed gear, the fan housing mounted within the discharge housing;
a fan wheel rotatably mounted within the fan housing; and
an auxiliary motor positioned adjacent the discharge housing and mechanically coupled to the toothed gear,
wherein the controller of the microwave appliance is in operable communication with the auxiliary motor, the controller configured to:
detect a first air quality characteristic;
compare the first air quality characteristic to a threshold characteristic;
suggest a position of fan housing to align the outlet with a selected one of the plurality of discharge ports;
receive an input indicative of the selected one of the plurality of discharge ports;
adjust the fan housing to the suggested position in response to the received input; and
operate the fan wheel to circulate air through the selected one of the plurality of discharge ports.

12. The appliance of claim 11, wherein the controller is further configured to detect a second air quality characteristic and compare the second air quality characteristic to the threshold characteristic.

13. The appliance of claim 12, wherein comparing the second air quality characteristic to the threshold characteristic comprises the controller configured to determine the second air quality characteristic satisfies the threshold characteristic, wherein the controller is further configured to deactivate the fan wheel in response to determining the second air quality characteristic satisfies the threshold characteristic.

14. The appliance of claim 11, wherein suggesting the position of the fan housing to align the outlet with the selected one of the plurality of discharge ports comprises the controller further configured to transmit a notification indicative of the suggested position to the external device.

15. The appliance of claim 11, wherein receiving the input indicative of the selected one of the plurality of discharge ports comprises the external device transmitting a signal indicative of the discharge port of the plurality of discharge ports that has been selected.

16. The appliance of claim 11, wherein adjusting the fan housing to the suggested position comprises the controller further configured to operate the auxiliary motor to rotate the fan housing such that the outlet of the fan housing aligns with the selected one of the plurality of discharge ports.

17. The appliance of claim 11, wherein detecting the first air quality characteristic comprises the controller further configured to receive data from the external device, wherein the external device is one or more of a database, a smartphone, and a sensor.

18. The appliance of claim 11, wherein detecting the first air quality characteristic comprises the controller configured to detect one or more of temperature, allergen content, and smoke in air.

19. The appliance of claim 11, wherein the plurality of discharge ports comprises three discharge ports facing in three different directions.

20. The appliance of claim 19, wherein one of the three discharge ports is positioned on a top side of the discharge housing, one of the three discharge ports is positioned on a front side of the discharge housing, and one of the three discharge ports is positioned on a back side of the discharge housing.
